(19) United States
(12) Patent Application Publication
(10) Pub. No.: US 2001/0054529 A1
(43) Pub. Date: Dec. 27, 2001

(54) VALVE AND A SHOCK ABSORBER BASED ON ELECTRORHEOLOGICAL LIQUIDS

(75) Inventors: ECKHARDT WENDT, LEVERKUSEN (DE); KLAUS BUSING, KOLN (DE); HORST SCHERK, OBER-RAMSTADT (DE); HORST ROSENFELDT, GROSSZIMMERN (DE)

Correspondence Address: WILLIAM C. GERSTENZANG, NORRIS MCLAUGHLIN & MARCUS, P.A., 220 EAST 42ND STREET, 30TH FLOOR, NEW YORK, NY, 10017, US

(73) Assignee: NORRIS MCLAUGHLIN & MARCUS P.A.

(21) Appl. No.: 09/134,055

(22) Filed: Aug. 14, 1998

(30) Foreign Application Priority Data
Aug. 19, 1997 (DE) 19735898.5

(51) Int. Cl. F16F 9/53

(52) U.S. Cl. 188/322.13; 188/267.1

(57) ABSTRACT

A valve and a shock absorber based on electrorheological liquids A valve and a shock absorber are described which are based on electrorheological liquids and which contain a valve aperture between two chambers, wherein the boundary faces of the valve aperture consist of electrically conductive material and are insulated from each other, and which comprise a source of high voltage, each of the voltage terminals of which can be connected to one of the boundary faces, with the characterising feature that the valve aperture has a meander-shaped cross-section.

Valves based on electrorheological liquids are based on the principle of influencing the fluidity of a liquid which passes through an aperture formed by two capacitor plates, and the viscosity of which is influenced by the electric field which prevails between the capacitor plates, so that the resistance to flow of the liquid alters due to the aperture.

Valves such as these are used in particular in the form of active shock absorbers and damping bearings; e.g. see U.S. Pat. No. 2,661,596 and U.S. Pat. No. 4,880,216. In this respect, the expression “active” means that the damping behaviour of shock absorbers and bearings of this type can be controlled, based on the instantaneously prevailing state of movement and via movement sensors, by controlling the electric field generated between the capacitor plates (valve aperture).

The switching factor denotes the relationship between the shearing stress which can be transmitted with (τ_{E}) and without (τ₀) the effect of a field. It is defined as the ratio of τ_{E}, namely the additional shearing stress which can be transmitted, to the base stress τ₀.

The switching factors which could be obtained hitherto constituted an obstacle to the widespread use of electrorheological valves in hydraulics and for shock absorbers and damping bearings.

The object of the present invention was to provide valves of this type which exhibit a multiple increase in their switching factor, and which in addition are suitable for widespread use due to their constructional simplicity.

The present invention relates to a valve based on electrorheological liquids, containing at least one first chamber which is connected via a valve aperture to at least one second chamber, wherein the chambers and the aperture are filled with an electrorheological liquid, the boundary faces of the valve aperture consist of electrically conductive material and are electrically insulated from each other, and comprising a source of high voltage, each of the voltage terminals of which can be connected to one of the boundary faces, with the characterising feature that the valve aperture has a meander-shaped cross-section.

The valve aperture is preferably constructed so that the direction of flow through the valve aperture is rectilinear and the cross-section of the valve transverse to the direction of flow is of meander-shaped construction. Due to the form of the valve aperture according to the invention, a relatively large flow cross-section can be produced for a small aperture width, so that a high switching factor is achieved.

The valve according to the invention preferably consists of a cylindrical housing which contains the first and second chambers as well as built-in components for the separation of the chamber whilst leaving a valve aperture free which is parallel to the cylinder axis.

According to the invention, the width of the valve aperture, i.e. the spacing between the two conducting boundary faces of the valve aperture, can be less than 1 mm, preferably less than 0.6 mm. Valve apertures between 0.2 and 0.5 mm are particularly preferred, so that the requisite voltage for shutting off the valve can be maintained within the range from 1 to 3 kV.

The extent of the valve aperture in the direction of flow, i.e. the aperture length, can be 20 to 200 times the aperture width.

Due to the cross-section of the valve aperture, which is meander-shaped according to the invention, it is possible to achieve very large extents of the aperture whilst keeping the cross-sectional area of the chambers provided on both sides of the aperture comparatively small. In this respect, the extent of the aperture transverse to the direction of flow can amount to 2 to 50 times,. preferably 200 to 3000 times, the aperture length. Free flow cross-sections through the valve aperture of several cm², particularly 1 to 5 cm², are thus achieved. The present invention also relates to a valve in the form of a shock absorber, wherein the built-in component for the separation of the chambers is constructed in the form of a piston which is axially displaceable in the cylindrical housing, wherein the piston comprises a meander-shaped valve aperture, is attached to an axial piston rod and the piston rod is led out of the housing.

Electrorheological liquids which are suitable for use according to the invention are dispersions of finely divided hydrophilic particles in hydrophobic, electrically non-conducting oils (these are generally colloidal suspensions of electrically polarisable, non-conducting particles), the flow limit of which changes rapidly and reversibly, and which under some circumstances changes by several orders of magnitude, under the effect of an electric field of sufficiently high field strength. Under the effect of the electric field, the electrorheological liquid thus changes from a fluid state of aggregation, via a plastic state of aggregation, to a solid state of aggregation. Examples of suitable electrorheological liquids are disclosed in DE 3 517 281 Al, DE 3 536 934 Al, DE 3 941 232 Al, DE 4 026 881 Al, DE 4 131 142 Al and DE 4 119670 Al.

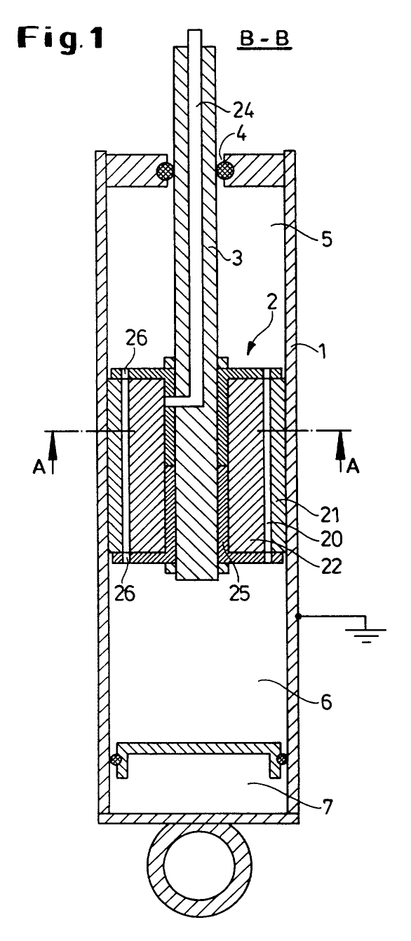

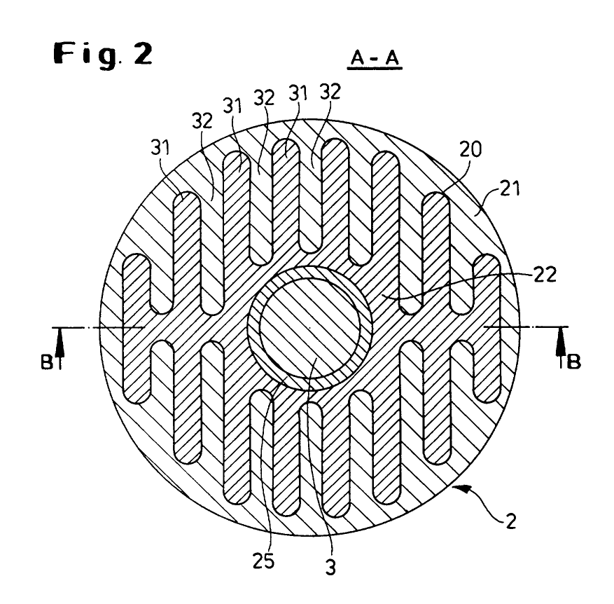

The invention is described in greater detail with reference to the accompanying FIGS. 1 and 2, which illustrate an example of a shock absorber.

FIG. 1 is a longitudinal section through a shock absorber according to the invention; and

FIG. 2 is a cross-section through a shock absorber according to the invention.

The shock absorber shown in FIG. 1 consists of a cylindrical housing 1, which comprises an axially displaceable piston 2 which is attached to a piston rod 3 and which is led out of the housing 1 via the lead-through 4. The piston 2 separates the two chambers 5 and 6, which are filled with an electroviscous liquid. In addition, a compressed air chamber 7 is provided which serves to compensate for thermal changes in volume of the electrorheological liquid. The valve aperture 20 passes through the piston 2, wherein the outer valve aperture boundary face 21 is formed from conductive material which is in contact with the earthed housing 1. The inner valve aperture boundary face 22 also consists of conductive material and is connected to the high voltage lead 24 which is led through the piston rod 3. The piston rod 3 is insulated from the piston 2 by the insulating layer 25. In addition, the outer and inner boundary faces 21 and 22 are mechanically joined by the insulating material 25. A multiplicity of bores through the insulating plates 25 which join piston elements 21 and 22 enable the electrorheological liquid to enter and emerge from the valve aperture 20.

FIG. 2 is a section A-A through the piston 2 shown in FIG. 1. The same reference numerals denote the same elements as in FIG. 1. For reasons of simplifying the drawing, the valve aperture 20 is illustrated as a solid, black, meander-shaped line. The inner and outer electrodes 21 and 22 each comprise a multiplicity of spines 31 and 32, which are parallel to each other for reasons of production technology, and which interlock whilst leaving the valve aperture 20 free. According to the invention, it is of course not impossible for the spines 31 and 32 also to be disposed radially.

1. A valve based on electrorheological liquids, containing at least one first chamber which is connected via a valve aperture to at least one second chamber, wherein the chambers and the aperture are filled with an electrorheological liquid, the boundary faces of the valve aperture consist of electrically conductive material and are electrically insulated from each other, and comprising a source of high voltage, each of the voltage terminals of which can be connected to one of the boundary faces, characterised in that the valve aperture has a meander-shaped cross-section.

2. A valve according to claim 1, characterised in that the cross-section of the valve aperture transverse to the direction of flow from one chamber to the other is of meander-shaped construction.

3. A valve according to claims 1 or 2, consisting of a cylindrical housing which contains the first and second chambers as well as built-in components for the separation of the chambers whilst leaving a valve aperture free which is parallel to the cylinder axis.

4. A valve according to claim 3, wherein the valve aperture is constructed in the form of a meander-shaped annular aperture.

5. A valve according to any one of claims 1 to 4, wherein the ratio of the aperture width to the aperture length is 1/20 to 1/200.

6. A valve according to any one of claims 1 to 5, wherein the ratio of the extent of the aperture transverse to the direction of flow to the aperture length is 3 to 50, preferably 10 to 20.

7. A valve according to any one of claims 3 to 5 in the form of a shock absorber, wherein the built-in component for the separation of the chambers is constructed in the form of a piston which comprises a valve aperture and which is axially displaceable in the cylindrical housing, the piston is attached to an axial piston rod and the piston rod is led out of the housing.
